(19) United States
(12) Patent Application Publication
(10) Pub. No.: US 2011/0005690 A1
(43) Pub. Date: Jan. 13, 2011

(54) Window Covering

(75) Inventor: Garry Harding, Bend, OR (US)

Correspondence Address: HANCOCK HUGHEY LLP, P.O. BOX 1208, SISTERS, OR, 97759, US

(73) Assignee: D & G Blinds & Shutters, Inc., Bend, OR (US)

(21) Appl. No.: 12/499,167

(22) Filed: Jul. 8, 2009

(51) Int. Cl. E06B 9/24

(52) U.S. Cl. 160/84.03

(57) ABSTRACT

A window covering offers significant options and control with respect to the amount of light that enters a room. The invention is embodied in a first illustrated embodiment with an upper blind portion that has a head rail attached to a header plates and which is adjustable from the top down, and a separate lower blind portion that has a bottom rail attached to the sill plate and is similarly but independently adjustable from the upper blind portion. The two portions in combination provide a highly variable window covering system. In an alternative embodiment, the upper and lower components of the window covering share a middle rail that defines a lower rail for the upper component, and an upper rail for the lower component, in which the upper and lower rails of the respective upper and lower components are separable from the associated header and sill plates.

### FIELD OF THE INVENTION

This invention relates to window coverings for use in homes and offices, and other settings such as recreational vehicles, and more specifically, to a window covering that includes multiple independently adjustable components that together are configured for moving the different components of the window covering to a variety of different positions to allow for multiple positional options.

### BACKGROUND

There are numerous styles of window coverings available on the market today. Common styles of window coverings, also called window blinds, include Venetian blinds, roll up shades and so-called “top down” coverings, among many others. The popular Venetian blind provides the user with a wide range of options for opening and closing the blind, and also for varying the amount of light (and visibility) that is allowed through the window. A Venetian blind typically includes a head rail, a bottom rail and plural slats between the head rail and bottom rail that may be angularly varied with control cords to change the angular position of the slats relative to the window. By changing the angular position of the slats, the amount of light entering the room through the window may be varied. In addition, lift cords allow the bottom rail and slats to be vertically lifted to any number of positions so that the window may be fully or partially exposed.

There are many variations on the basic Venetian blind just described. For example, window covering systems that utilize pleated fabrics instead of the more traditional slats used in Venetian blinds have become popular. A pleated window covering typically uses pre-pleated fabrics that have permanently fixed pleats that define laterally extending cells that may be tightly compressed when the window covering is open (i.e., when the covering is in a position that allows the window to be exposed), and which may be extended broadly when the covering is closed (i.e., when the covering is in a position to prevent the window from being visible). The material used to fabricate the pleats is often referred to as a “cellular” of “honeycomb” fabric, and may be opaque (often called “blackout” material), or may be selected to allow for transmission of some light through the material. Not only does such cellular material provide a variety of light transmission qualities, the fabric tends to provide significant insulating properties.

Vertical slat blinds are also a popular type of window covering that are similar in many respects to a Venetian blind except the slats extend vertically rather than horizontally. The vertical slats share the same functionality as horizontal slats since they may be angularly adjusted relative to the window pane to adjust the amount of light transmitted through the blind, and the slats may be pulled horizontally to “open” and “close” the blind system.

There are also a variety of cordless top down and bottom up blinds on the market, and most of these use cellular pleated fabric. A top down or bottom up blind has vertical cords extending from the head plate to the sill plate of the window opening. In a top down/bottom up blind, the bottom rail is not attached to the sill plate of the window and a middle rail may be adjusted vertically to open and close the blind. In some bottom up blinds, the top rail is attached to the head plate and the bottom rail may be adjusted vertically. Regardless of the particular configuration of these types of blinds, because there are exposed cords with this kind of system, there are safety concerns with respect to dangers to children and pets posed by freely hanging cords.

But despite the numerous improvements in the number and types of window coverings available, there is an ongoing need for a window covering that provides a range of light control options and opening and closing positions.

The present invention relates to a window covering that features attributes of top down and bottom up blinds combined with other structural features that allow the window covering to offer more options and control with respect to the amount of light that enters a room. The invention is embodied in a first illustrated embodiment with an upper blind portion that is adjustable from the top down and the bottom up, and a separate lower blind portion that is similarly but independently adjustable from the upper blind portion. The two portions in combination provide a highly variable window covering system.

In a second illustrated and alternative embodiment, the upper and lower components of the window covering work in concert with one another to allow variability in the amount of light entering through a window, but the two components share a middle rail. Neither of the upper or lower rails is attached to the respective header and sill plates of the window opening, and all of the rails are independently movable with respect to the plates. Movement of the shared middle rail allows for variable adjustment of either/both the upper and/or lower components of the window covering.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of a first illustrated embodiment of the window covering of the present invention showing the blind system mounted in a standard window opening.

FIG. 2 is an elevation, partially cut away and partially schematic view showing the window covering system of FIG. 1 and illustrating some of the internal components.

FIG. 3 is a cross sectional view taken along the line 3-3 of FIG. 2.

FIG. 4 is an elevation, partially cut away and partially schematic view showing the window blind system of FIG. 1 with the upper and lower blind components in retracted positions.

FIG. 5 is a perspective view of a second illustrated embodiment of the present invention showing the blind system mounted in a standard window opening.

FIG. 6 is an elevation, partially cut away and partially schematic view of the alternative embodiment shown in FIG. 5, illustrating the window blind system some of the internal components.

FIG. 7 is yet another alternative embodiment similar to the embodiment of FIG. 1 except the upper component of the window covering has been eliminated and the window covering has only a lower component.

### DETAILED DESCRIPTION OF THE PREFERRED EMBODIMENTS

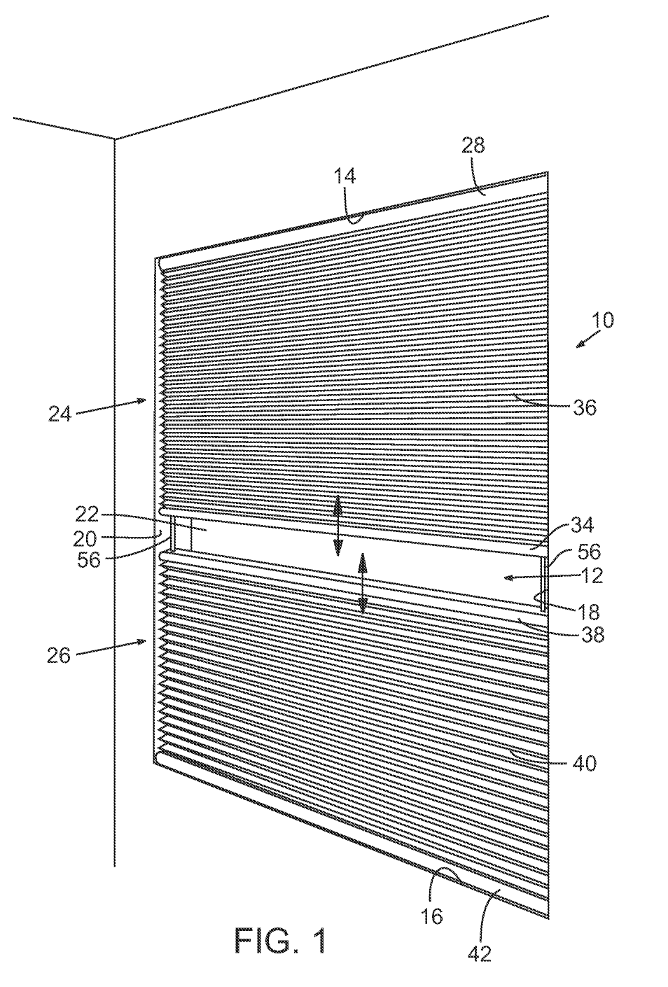

A first illustrated embodiment of a window covering 10 incorporating the present invention is shown in FIGS. 1 through 4. For the purposes of uniformity of description and to define a common linguistic convention used in this specification, relative directional terms used herein correspond to the geometric center of the window covering 10 and how the window covering is mounted in a typical window opening in standard fashion, as shown in FIG. 1. Using this convention, the “inner” or “interior” side of the window covering is that portion of the window covering that faces the interior of the room in which the window is framed. The “outer” side of the window covering is that side of the covering that faces the glass panels of the window itself. “Upper” refers to the direction toward the top of the window opening, and “lower” refers to the opposite direction, toward the floor. With reference to FIG. 1, the window covering 10 is mounted in a standard window opening 12 that is defined by an upper header plate 14, a sill plate 16 opposite the header plate, and opposed vertically oriented side plates 18 and 20. The glazing material, which may be any type of glazing such as double pane glass, is identified with reference number 22.

Although the window covering 10 illustrated herein is shown in a conventional rectangular shaped window, the invention is not limited to this shape or any other, and the window covering may be fabricated to fit in a window having a different shape.

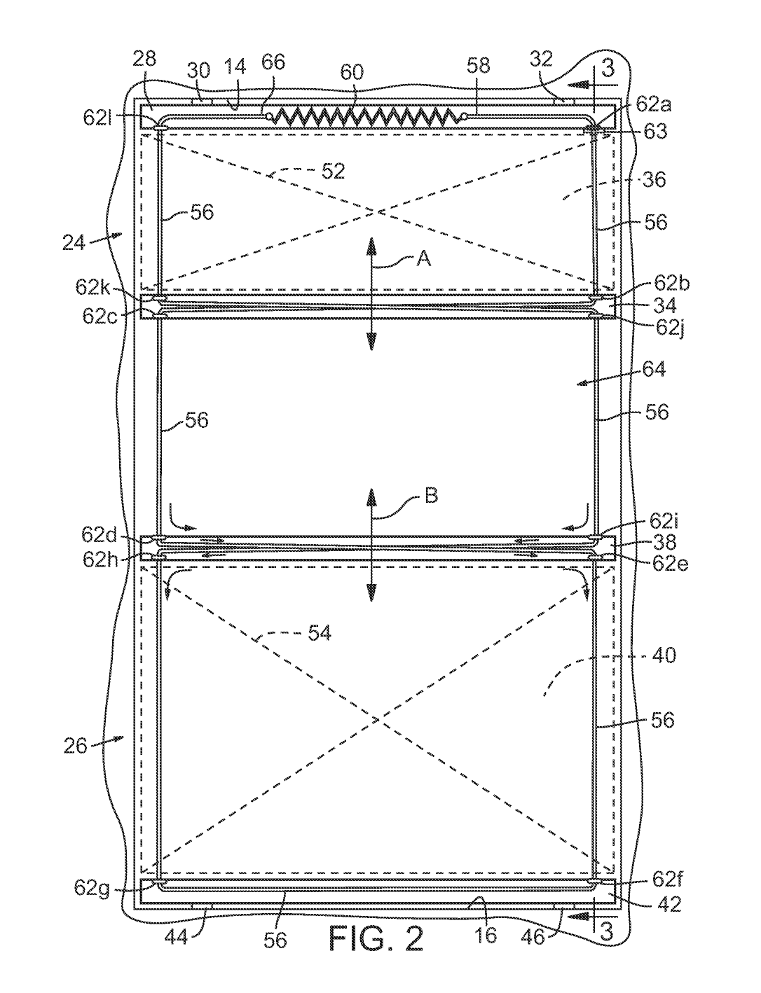

Window covering 10 comprises an upper component or module that is identified generally with reference number 24, and a lower component or module 26. Upper component 24 includes a head rail 28 that is attached to header plate 14 of window opening 12 with brackets 30 and 32 (FIG. 2). Upper component 24 also includes a lower rail 34. The window blind material 36 is connected to the head rail 28 and lower rail 34 in a conventional manner. Similarly, the lower component 26 includes a head rail 38, blind material 40 and a lower rail 42 that is attached to sill plate 16 with brackets 44 and 46. Specifically, the cells of the fabric used to define the blind material that are immediately adjacent the head and lower rails contain an elongate, plastic stiffener that runs longitudinally through the cells and retains the blind material in the channel defined by the rails in a conventional manner. In the figures the blind material 36 and 40 is shown as conventional “cellular” fabric. It will be understood that any material may be used to define the blind material, including dual cellular fabric and the like. Further, the material used to define different portions of the window covering may be selected for its light transmission properties. For example, “blackout” material may be selected for the blind material 36 of upper component 24. This material is opaque so that light is not transmitted through it. A lighter blind material that transmits some light may be used for the blind material 40 of lower component 26. There are many, many different types of blind materials available that will work with the present invention, and many different options for such materials such as the amount of light that may be transmitted through the materials, the colors, etc. As detailed below, by selecting blind material having different light transmission qualities for the upper component versus the lower component allows the window covering 10 according to the present invention to provide many different options with respect to the amount of light allowed to enter through the window.

Turning to FIG. 2, window covering 10 includes a control system 50 that allows the upper and lower components 24 and 26 to be variably positioned in window opening 12. In FIG. 2 the blind materials 36 and 40 of upper components 24 and 26, respectively, is shown schematically with a dashed X with reference numbers 52 and 54 so that the internal routing of the cord may be easily seen. The control system 50 is defined by a continuous control cord 56 that is routed through the upper and lower components. Specifically, tracing the routing of control cord 56 beginning from the head rail 28, a first end 58 of control cord 56 is fixed to a spring 60 that is housed within head rail 28. The control cord extends horizontally within the head rail and exits the head rail through a grommet 62a that defines an opening through the head rail. A conventional cord guide 63 is used at each grommet described below in order to guide the cord 56 into the fabric. One cord guide 63 is illustrated as it is positioned next to grommet 62a, but the remaining cord guides are omitted for clarity of the drawings. The cord 56 extends vertically in the downward direction through the blind material 36 (again, illustrated schematically in FIG. 2) and enters lower rail 34 through a grommet 62b. The cord extends horizontally through the interior of lower rail 34 to the opposite side of the rail, and exits through grommet 62c. Cord 56 extends vertically again at this point and extends through the open space 64 between the upper and lower components 24 and 26, entering head rail 38 of lower component 26 through grommet 62d. The cord then extends horizontally along the interior space of head rail 38, exiting the interior space through grommet 62e, where the cord 56 extends vertically through the blind material 40 until the cord enters lower rail 42 through grommet 62f.

Tracing the cord 56 from grommet 62f, the cord extends horizontally through the lower rail 42 and makes a 90 degree turn to exit the rail at grommet 62g, where the cord is routed vertically through the blind material 40 so that the cord enters head rail 38 through grommet 62h. The cord turns 90 degrees so that it extends horizontally through head rail 38, crossing itself near the center of head rail 38 as illustrated, and exiting the head rail at grommet 62i. The cord 56 then extends vertically across open space 64 and enters lower rail 34 of upper component 24 at grommet 62j. The cord again turns so that it runs horizontally through lower rail 34, crossing itself near the center of the rail, and exiting the lower rail 34 at grommet 62k. The cord 56 runs vertically through blind material 36, entering head rail 28 at grommet 62l. The second end 66 of cord 56 is attached to spring 60 at the end of the spring opposite the end of the spring to which first end 58 of the cord is attached.

Spring 60 is typically a spirally-wound spring and it is selected and sized so that cord 56 is under tension at times, regardless of the relative positions of upper components 24 and 26. Stated another way, because cord 56 is always under tension by virtue of both ends of the cord being attached to spring 60, there is at no time any slack in the cord. The spring 60 is not fixed to the head rail 28 and “floats” freely within the interior portion of the head rail. The size—that is, diameter—of the cord 56 and the size of the openings in the grommets 62 are cooperatively selected so that there is a close tolerance fit between the cord and the opening in the grommet. This results in frictional engagement between the cord and the grommet that allows the grommet and rail to slide along the cord in the vertical direction. Because there is friction between the grommets and the cord, the rails stay in place relative to the cords unless the position of one of the rails is being adjusted. The cords may be conventional cord materials such as woven cords, or may be wire, woven wire, plastic, and the like.

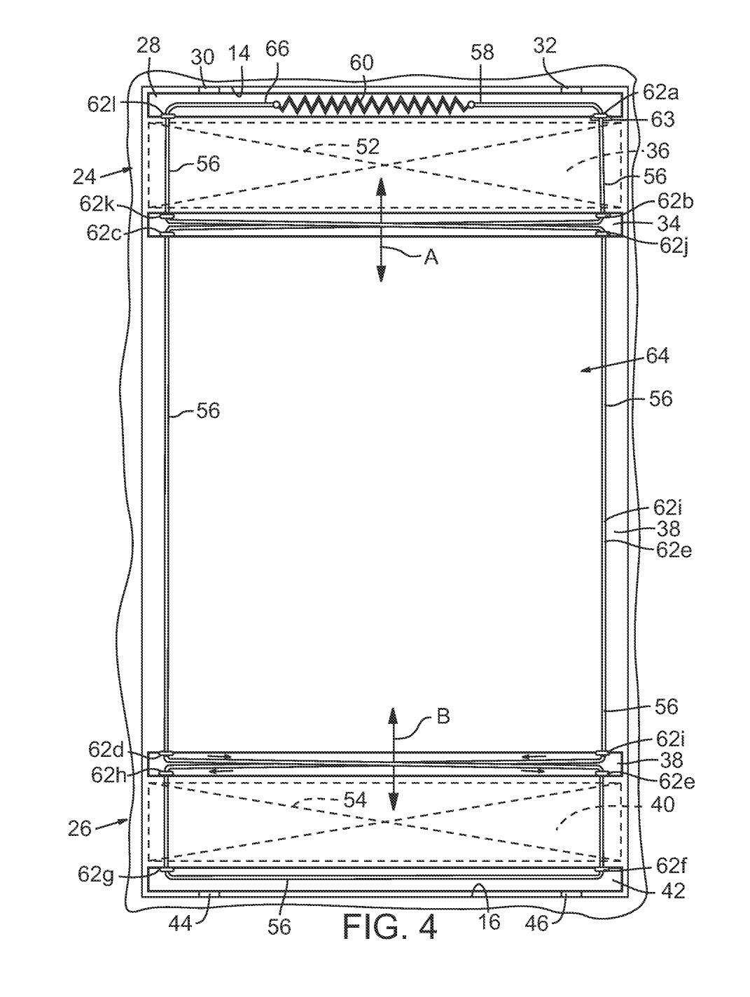

Operation of window covering 10 will now be described with particular reference to FIGS. 2 and 4. As noted previously, head rail 28 of upper component 24 is attached to the header plate 14 of the window opening with brackets 30 and 32. As such, the head rail is not movable. Similarly, lower rail 42 of lower component 25 is attached to the sill plate 16 with brackets 44 and 46 and is immovable. However, both the lower rail 34 of upper component 24 and head rail 38 of lower component 36 are vertically and independently movable. This is shown in FIG. 2 with arrows A and B. For example, if lower rail 34 is moved downwardly in the direction of arrow A, head rail 28 remains fixed in its attachment to the header plate 14 while the lower rail 34 moves away from the head rail. As this happens, the cord 56 slides through the various grommets 62 and the blind material 36 expands. Head rail 38 of lower component 26 does not move as lower rail 34 of upper component 24 moves in the direction of arrow A, unless the head rail 38 and lower rail 34 are abutting one another. By adjusting the position of lower rail 34 in this manner the amount of the window opening that is covered by the upper component 24 may be adjusted to any position between the fully open position—that is, where lower rail 34 is moved upwardly as far as possible, to the point where the blind material 36 is fully compressed so that the rail may not move further and the upper component is fully compressed, to the fully closed position—that is, where the lower component 26 is fully compressed and lower rail 34 of the upper component abuts the upper rail 38 of the lower component.

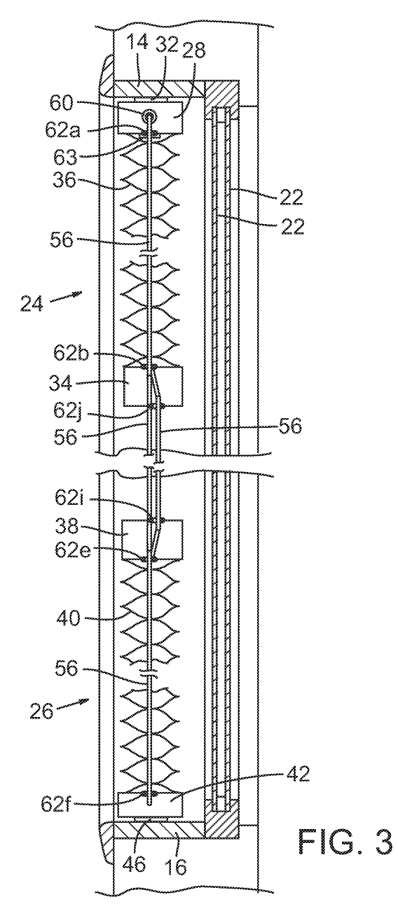

The lower rail 34 will remain in whatever vertical position desired. Likewise, upper rail 38 of lower component 26 will remain in a desired position relative to the window opening. As best illustrated in FIG. 3, because there is tension applied to the cord 56 by spring 60, because the cord 56 crosses itself in each rail, and also in view of the friction existing between the cord 56 and the grommets 62, the lower rail will not move without it being pulled down or pushed up and all of the rails maintain their position relative to the window opening and will not slip downwardly.

Similarly, the lower component 26 is independently adjustable relative to the upper component 24. Thus, the head rail 38 may be moved upwardly in the direction of arrow B, or downwardly in the direction of arrow A. There is enough blind material 40 in lower component 24 that the head rail 38 may be moved to the fully upward position—that is, where lower rail 34 of upper component 24 is moved upwardly as far as possible, to the point where the blind material 36 of the upper component is fully compressed so that the rail may not move further, with head rail 38 abutting lower rail 34. In the opposite position, head rail 38 is moved to the fully downward position—that is, where the lower component 26 is fully compressed.

It will be appreciated that because either of the upper or lower components 24 or 26 may be either fully “open” or fully “closed”, independently of one another, there are an infinite number of positional combinations that may be selected to vary the amount of light transmitted into the room. For example, with upper component 24 fully compressed and lower component 26 fully compressed, the window covering system is “open” to allow the maximum amount of light into the room. Assuming that one of either the upper or lower components utilizes blind material that is “blackout” material, and the other component allows some light transmission (i.e., uses semi-opaque material), then the two components may be adjusted together to vary widely the amount of light entering the room. If the blind material used in upper component 24 is blackout material, the window covering may be “closed” completely and the window blacked out by moving lower rail 34 into the fully extended, or lowermost position. On the other hand, if the blind material used in lower component 26 is semi-opaque, upper rail 38 may be moved into the fully extended, or uppermost position to allow a substantial amount of light into the room, yet still allow privacy since a person standing outside of the window would not be able to see inside.

The “fully” open position for the window covering 10 is shown in FIG. 4. In this position, lower rail 34 of upper component 24 is moved upwardly until the blind material 36 can be compressed no further. Upper rail 38 of lower components 26 is moved downwardly to the position where the blind material 40 may be compressed no further. This maximizes the size of the open space 64.

The embodiments illustrated in the figures are referred to in the industry as “horizontal” window coverings—the header rails and window covering materials extend horizontally across the window relative to the ground plane. It will be appreciated that the inventions described herein may be utilized in a “vertical” orientation as well. Thus, with reference to the embodiment of FIG. 1 as an example, the vertical orientation is accomplished by rotation of the entire window and window covering 10 by 90 degrees to the right (i.e., in the clockwise direction) so that the header plate 14 and sill plate 16 define the opposed vertically oriented side plates, and the side plates 18 and 20 define the header and sill plates, respectively. The window covering 10 in this vertical orientation functions identically as the horizontal orientation detailed above.

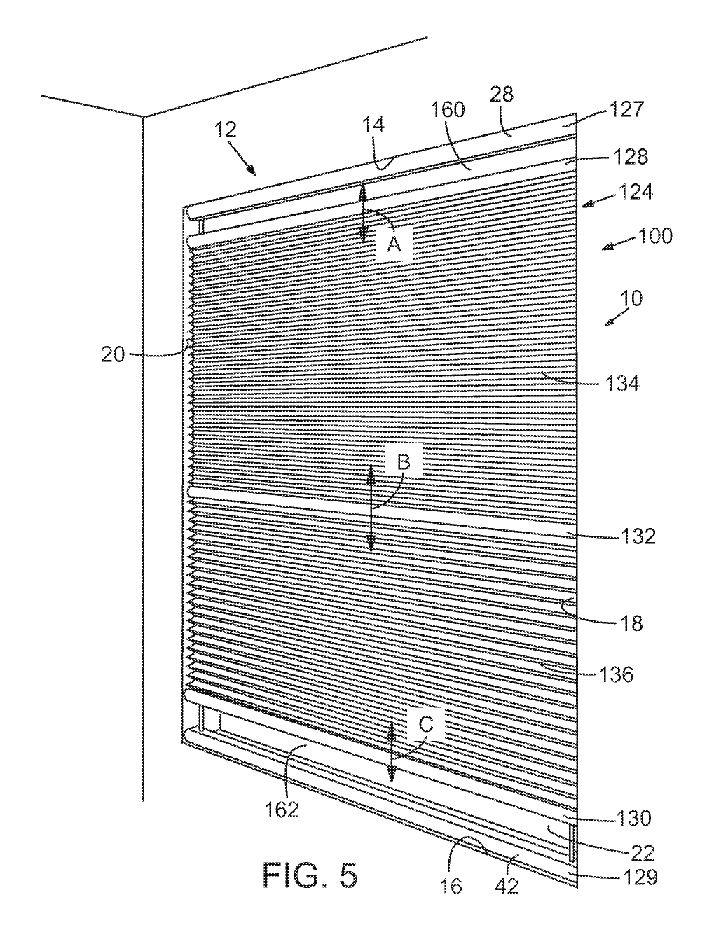

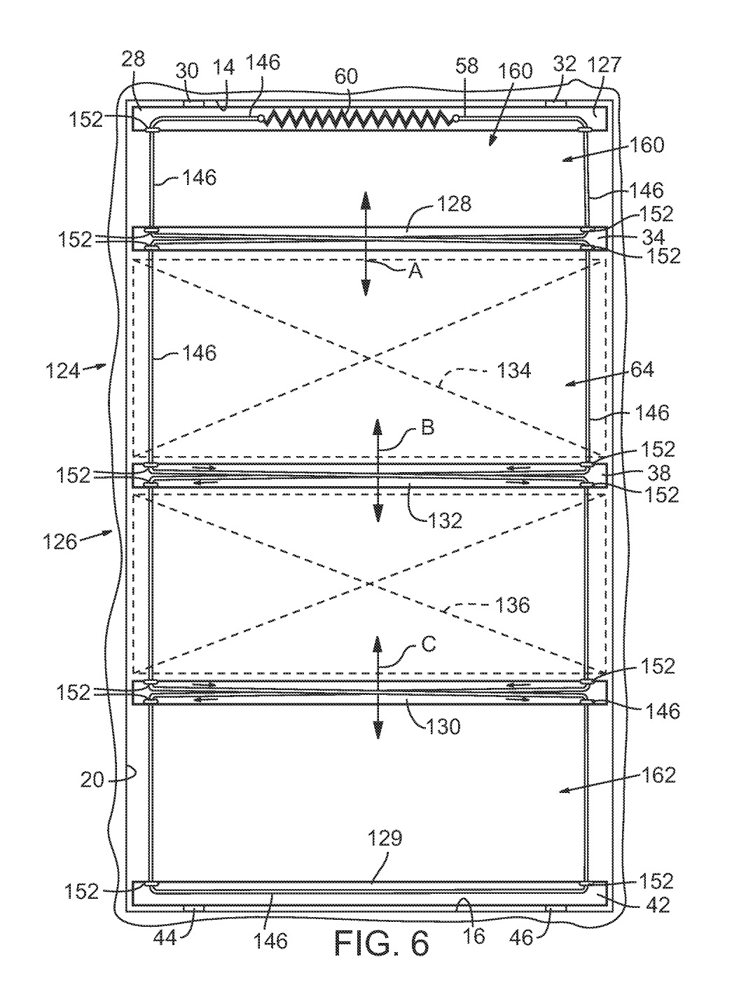

With reference now to FIGS. 5 and 6, a second illustrated and alternative embodiment of a window covering according to the present invention is shown mounted in a standard window opening 12 that is defined by an upper header plate 14, a sill plate 16 opposite the header plate, and opposed vertically oriented side plates 18 and 20. The glazing material, which may be any type of glazing such as double pane glass, is identified with reference number 22.

As with the window covering 10 illustrated in FIGS. 1 through 4, the window covering 100 of FIGS. 5 and 6 is shown in a conventional rectangular shaped window, but the window covering may be fabricated to fit in a window having a different shape.

Window covering 100 comprises an upper component that is identified generally with reference number 124, and a lower component 126. Upper component 124 includes a head rail 127 that is fixed to header plate 14 with brackets, and upper rail 128. Lower component 126 includes a sill plate rail 129 that is fixed to sill plate 16 with brackets and a lower rail 130. A middle rail 132 is positioned between the upper and lower rails 128 and 130—the window blind material 134 that is a portion of the upper component 124 is attached at its upper edge to head rail 128 and at its lower edge to middle rail 132. As may be seen from the illustrations, the upper rail 128 is not fixed to head rail 127, and the lower rail 130 is not fixed to sill plate rail 129. The blind material 136 that is a portion of the lower component 126 is attached at its upper edge to middle rail 132 and at its lower edge to lower rail 130. In this manner, as shown in FIG. 5, middle rail 132 is a shared component of both upper component 124 and lower component 126 and as detailed below, movement of middle rail 132 moves the blind materials 134 and 136 of both the upper and lower components simultaneously. The middle rail 132 thus defines a lower rail for upper component 124, and separately, an upper rail for lower component 126. As detailed below, movement of any one of the three rails (i.e., upper rail 128, middle rail 132, and lower rail 130) does not cause movement of any of the other rails.

The blind materials 134 and 136 are shown as conventional “cellular” fabric and may be the same kinds of fabrics described above. Blackout material may be selected for the blind material 134 of upper component 124, or for the blind material 136 of lower component 126. When blackout material is used for one of either the upper or lower components, a semi-opaque blind material that transmits some light is typically used for the other component.

As best illustrated in FIG. 6, window covering 100 includes a control system 140 that allows the upper and lower components 124 and 126 to be variably positioned in window opening 12. In FIG. 6 the blind materials 134 and 136 of upper components 124 and 126, respectively, are shown schematically with a dashed X with reference numbers 142 and 144 so that the cord that is used in the control system 140 may be easily seen. The control system 140 is analogous to the control system 50 described above with respect to the embodiment of FIGS. 1 through 4. Specifically, control system 140 is defined by a continuous control cord 146 that have its first end attached to a spring 60 that is housed within head rail 127. In the same manner as detailed above, and as shown in FIG. 6, the cord 146 is routed through each of the rails (i.e., head rail 127, upper rail 128, middle rail 132, lower rail 130 and sill plate rail 129) with the cord crossing itself in the rails. It will be appreciated that the cord 146 extends through grommets and cord guides as detailed above, and that the second end of cord 146 is attached to the opposite end of spring 60.

The size of the cord 146, and the size of the openings in the grommets 152 are cooperatively selected so that there is a close tolerance fit between the cords and the openings in the grommet. This results in frictional engagement between the cords and the grommets that allows the grommet and rail (e.g., head rail 128) to slide along the cords in the vertical direction (arrows A, B and C in FIG. 6). Because there is friction between the grommets and the cords, the rails stay in place where they are set relative to the cords and the rails do not move unless they are being adjusted. Moreover, the cord itself supports the horizontal positions of the rails because the cords cross over themselves within each rail. As noted previously, the cord may be fabricated from a variety of materials.

The alternative embodiment of FIGS. 5 and 6 allows for substantial variability in the placement of the upper and lower components 124 and 126, and therefore in the amount of light that enters through window 22. Since neither of the upper or lower rails 128 or 130 are attached to the respective adjacent header rail 127 or sill plate rail 129, there may be an adjustable open space 160 above upper component 124, and an adjustable open space 162 below the lower component 126. For example, the upper or lower components 124 or 126 may be either fully “open” or fully “closed”, independently of one another, there are an infinite number of positional combinations that may be selected to vary the amount of light transmitted into the room. Upper rail 128 may be moved fully upward in the direction of arrow A so that the rail abuts header rail 127. Likewise, lower rail 130 may be moved fully downward in the direction of arrow C so that the lower rail abuts the sill plate rail 129. The middle rail 132 may be moved to any position between these two extremes (arrow B). Assuming that one of either the upper or lower components 124 or 126 utilizes blackout blind material, and the other component allows some light transmission (i.e., uses semi-opaque material), then the two components may be adjusted together to vary widely the amount of light entering the room. If the blind material 134 used in upper component 124 is blackout material, the window covering may be “closed” completely and the window blacked out by moving lower rail 130 to the lowermost position, moving middle rail 132 to the lowermost position (so that blind material 136 in lower component 126 is fully compressed), and moving upper rail 128 to the fully upward position with the rail abutting the header plate 14. If the blind material used in lower component 126 is semi-opaque, upper rail 128 may be moved into uppermost position and the middle rail 132 may be adjusted to vary the amount of light allowed into the room.

The window covering 100 may be fully “opened” by moving each of the three rails 128,130 and 132 to either the uppermost or lowermost positions, which maximizes the size of the open spaces 160 or 162. It will be appreciated based on the description above in combination with the arrows A, B, and C in FIGS. 5 and 6, which illustrate the directions in which each of the three movable rails are capable of being moved, that there are innumerable combinations of positions in which the rails may be placed to adjust the amount of light allowed into the room.

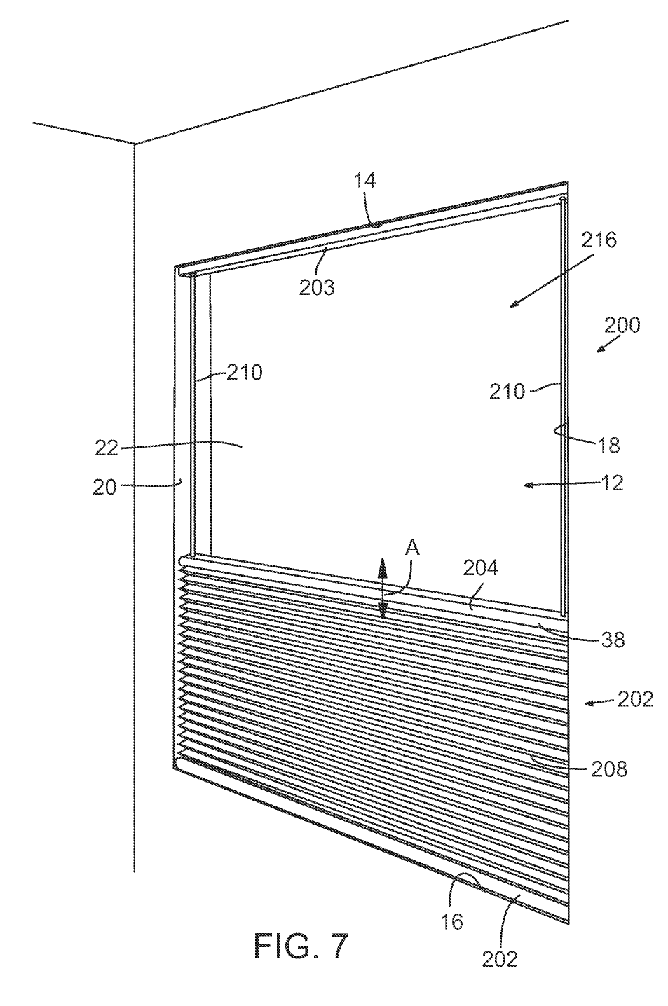

Turning now to FIG. 7, yet another embodiment of a window covering 200 is illustrated that has only a single component 202 and which is installed in a window opening 12 identical to those described above. Window covering 200 is defined by a movable upper rail 204, a header rail 203 that is fixed to header plate 14 and a lower rail 206 that is fixed to sill plate 16. Blind fabric 208 is attached at its upper edge to upper rail 204 and at its lower edge to lower rail 206. The embodiment of FIG. 7 includes a cord 210 that has its opposite ends attached to opposite ends of a spring contained in the header rail 203 as detailed above with respect to the embodiment of FIG. 2. Cord 210 extends into and across upper rail 204, through blind fabric 208 and into lower rail 204, then back upwardly to enter upper rail 204 and back through the upper rail in the crossing manner described earlier, then out of the upper rail 204 and into the header rail 203 where, as noted, the cord is attached to a spring (not shown).

With the embodiment of FIG. 7, only upper rail 204 is movable in the vertical direction (arrow A) and the upper rail may be moved completely upwardly in the window opening 12 to fully “close” the window covering. The window covering is opened by moving the upper rail downwardly to its lowermost position, which of course results in the maximum amount of open space 216 above the upper rail.

While the present invention has been described in terms of a preferred embodiment, it will be appreciated by one of ordinary skill that the spirit and scope of the invention is not limited to those embodiments, but extend to the various modifications and equivalents as defined in the appended claims.

I claim:

1. A window covering for a window having a header plate and a sill plate, comprising:
an upper component defined by a header rail fixed to the header plate, an upper component lower rail below the header rail that is movable relative to the header rail, and a first expandable blind material attached to the header rail and the upper component lower rail;
a lower component defined by a sill plate rail fixed to the sill plate, a lower component upper rail above the sill plate rail that is movable relative to the sill plate rail, and a second expandable blind material attached to the sill plate rail and the lower component upper rail;
wherein, the upper component lower rail and the lower component upper rail are independently movable relative to one another.

2. The window covering according to claim 1 including a control system defined by a cord having a first end attached to a spring in the header rail, said cord routed through the header rail and exiting the header rail near one end thereof and continuing through each of the other rails and having its second end attached to the spring.

3. The window covering according to claim 2 wherein said control system is further defined by said cord extending through all of said rails.

4. The window covering according to claim 3 wherein the cord enters the sill plate rail adjacent one lateral end thereof, extends through said sill plate rail, and exits said sill plate rail at the opposite lateral end.

5. The window covering according to claim 1 wherein movement of the upper component lower rail causes expansion or retraction of the first expandable blind material but not the second expandable blind material.

6. The window covering according to claim 5 wherein movement of the lower component upper rail causes expansion or retraction of the second expandable blind material but not the first expandable blind material.

7. The window covering according to claim 1 wherein movement of either of the upper component lower rail or the lower component upper rail causes expansion or retraction of both the first and second expandable blind materials.

8. The window covering according to claim 1 wherein the first and second expandable blind materials have different light transmission properties.

9. The window covering according to claim 1 in which the window defines a window opening, and wherein the entire window opening may be substantially occluded by either the upper component or the lower component.

10. The window covering according to claim 1 wherein the header rail and sill plate are oriented perpendicular to the ground plane.

11. A window covering for a window having a header plate and a sill plate, comprising:
a header rail fixed to the header plate;
a sill plate rail fixed to the sill plate;
an upper rail adjacent the header rail and movable relative thereto, and a lower rail adjacent the sill plate rail and movable relative thereto, and a middle rail between the upper and lower rails and movable relative to both;
a first expandable blind material attached to the upper rail and the middle rail;
a second expandable blind material attached to the middle rail and the lower rail.

12. The window covering according to claim 11 including a control system defined by a cord having a first end attached to a spring in the header rail, said cord routed through the header rail at one end thereof and continuing through each of the other rails and having its second end attached to the spring.

13. The window covering according to claim 12 wherein said control system is further defined by said cord extending through all of said rails.

14. The window covering according to claim 13 wherein the cord enters the sill plate rail adjacent one lateral end thereof, extends through said sill plate rail, and exits said sill plate rail at the opposite lateral end.

15. The window covering according to claim 11 wherein movement of the middle rail causes expansion and/or retraction of the first and second expandable blind materials.

16. The window covering according to claim 15 wherein when the middle rail may be moved independently of both the upper and lower rails.

17. The window covering according to claim 16 wherein the upper rail may be moved independently of both the middle and lower rails.

18 The window covering according to claim 17 wherein the lower rail may be moved independently of both the middle and upper rails.

19. A window covering for a window having a header plate and a sill plate, comprising,
a lower rail fixed to the sill plate, said lower rail having first and second opposed lateral ends and upper and lower sides;
an upper rail movable relative to the lower rail and having first and second opposed lateral ends and upper and lower sides
expandable blind material between the upper and lower rails, the expandable blind material attached to the lower side of the upper rail and to the upper side of the lower rail;
a control system defined by a cord having a first end fixed to the header plate near a first lateral edge thereof, said cord entering said upper rail through an opening formed in the upper side near the first lateral end thereof and extending longitudinally in said upper rail and exiting said upper rail through an opening formed in the lower side near the second lateral end, said cord extending through said expandable blind material and entering said lower rail through an opening formed in the upper side of said lower rail near the second lateral end of said lower rail, said cord extending longitudinally through said lower rail and exiting said lower rail through an opening formed in the upper side of said lower rail near the first lateral end, the cord extending through said expandable blind material and entering said upper rail through an opening formed in the lower side near the first lateral end of said upper rail, the cord extending longitudinally through said upper rail and exiting said upper rail through an opening formed in the upper side of said upper rail near the second lateral end thereof, and said cord having a second end fixed to the header plate near a second lateral edge thereof.

20. The window covering according to claim 19 wherein the header plate and sill plate are substantially perpendicular to a ground plane.
